(19) United States
(12) Patent Application Publication
(10) Pub. No.: US 2018/0025686 A1
(43) Pub. Date: Jan. 25, 2018

(54) METHOD AND DEVICE FOR EMULATING CONTINUOUSLY VARYING FRAME RATES

(71) Applicants: MAX-PANCK-GESELLSCHAFT ZUR FÖRDERUNG DER WISSENSCHAFTEN E.V., München (DE); UNIVERSITÄT DES SAARLANDES, Saarbrücken (DE)

(72) Inventors: Krzysztof TEMPLIN, Saarbrücken (DE); Karol MYSZKOWSKI, Saarbrücken (DE); Hans-Peter SEIDEL, St. Ingbert (DE); Piotr DIDYK, Homburg (DE)

(21) Appl. No.: 15/550,222

(22) PCT Filed: Feb. 11, 2016
(86) PCT No.: PCT/EP2016/000232

§ 371 Date: Aug. 10, 2017

Related U.S. Application Data
(60) Provisional application No. 62/114,672, filed on Feb. 11, 2015.

(30) Foreign Application Priority Data
Feb. 11, 2015 (EP) 15 154 734.6

(51) Int. Cl. G09G 3/20; G06T 3/40; H04N 5/262; H04N 21/4402; H04N 7/01; H04N 5/235

(52) U.S. Cl. CPC G09G 3/2092; H04N 7/0127; H04N 5/2353; H04N 5/2625; H04N 21/440245; H04N 21/440281; G06T 3/4007; G09G 2340/0435; G09G 2320/0247

(57) ABSTRACT

The present invention relates to a method and a device for emulating frame rates in video or motion picture.

The present invention relates to a method and a device for emulating frame rates in video or motion picture.

The visual quality of a motion picture is significantly influenced by the choice of the presentation frame rate.

Before introduction of sound films, around which time the standard of 24 fps was born, films were captured and projected at various frame rates. Sixteen frames per second were considered standard, but rates much lower as well as much higher than that were not uncommon, with some productions combining several rates within one show [Brownlow 1980].

Increasing the frame rate improves the clarity of the image and helps to alleviate many artifacts, such as blur, strobing, flicker, or judder. These benefits, however, come at the price of losing the well-established film aesthetics, often referred to as “cinematic look”. Current technology leaves artists with a sparse set of choices, e. g., 24 Hz or 48 Hz, limiting the freedom in adjusting the frame rate to the artistic needs, content, and display technology.

In the early 1980s, Douglas Trumbull developed the Showscan system running medium-format film at 60 fps, which gave the audience an experience of extremely high temporal and spatial resolution. In his experiments, increasing the frame rate amplified the emotional response in the audience. The new embodiment of these ideas—the Showscan Digital system—captures images at 120 fps using a nearly-360° shutter. This allows for integration of the frames, effectively simulating acquisition at several lower rates. The proposed system is complemented by the functionality to automatically combine two frame rates within one scene, depending on the pixel luminance temporal variation.

Increasing the acquisition and presentation frame rate helps to alleviate many artifacts of motion picture, such as blur, strobing, flicker, or double edges, and thus leads to a more faithful image reproduction. These artifacts, however, contribute to the well-established aesthetics of the film, and the reactions of the audiences to the increased frame rate have been mixed so far. Many commentators contrast the classic “other-worldly, cinematic look” of 24-fps motion pictures with the “cheap, soap-opera look” of films presented at higher frame rates. This is a paradoxical situation in which improving the objective reproduction quality leads to an inferior subjective experience. At the same time many people prefer the cleaner look of high frame rates, and a well-grounded argument has been put forward that increasing the frame rate helps to minimize the visual discomfort experienced during stereoscopic viewing.

It seems that high frame rates work better for certain types of content than the others (e. g., documentaries, sports events) or even certain types of shots within a single film (e. g., establishing shots). The choice of the frame rate, therefore, could be seen as a creative decision, and it was suggested that variable frame rates should be employed, so that the artist can select on the case-by-case basis the frame rate that best serves the story-telling purpose. Solutions combining two different frame rates have been proposed, however, they still give a rather limited control over the look of the film. In their short film Lucid Dreams of Gabriel, Disney Research demonstrated how to embed lower frame-rate content within higher frame-rate sequence (6 fps and 24 fps within 48 fps). It remains unclear, however, how to embed content whose frame rate is not a divisor of the higher frame rate without introducing video stutter. Similarly, Trumbull and Jackson discuss only certain combinations of frame rates, without the possibility to vary the frame rate continuously. Due to this limited choice of frame rate pairs, in certain situations either the film aesthetics or its objective quality has to be compromised.

It is therefore an object of the present invention to provide a method and a device for emulating continuously varying presentation frame rates.

This object is achieved by a method and a device according to the independent claims. Advantageous embodiments are defined in the dependent claims.

In summary, the invention introduce a technique for emulation of the whole spectrum of presentation frame rates on a single-frame-rate display. The novelty of our approach lies in the ability to vary the frame rate continuously, both in the spatial and the temporal dimension, without modifying the hardware in any way. This gives artists more creative freedom and enables them to achieve the best balance between the aesthetics and the quality of the motion picture. The inventive technique does not require foreground-background segmentation of the scene, and can operate automatically by analyzing the optic flow in the scene and locally adjusting the frame rate based on cinematic guidelines.

These and other aspects of the present invention will be more readily understood when studying the following detailed description of the invention, in relation to the annexed drawing in which

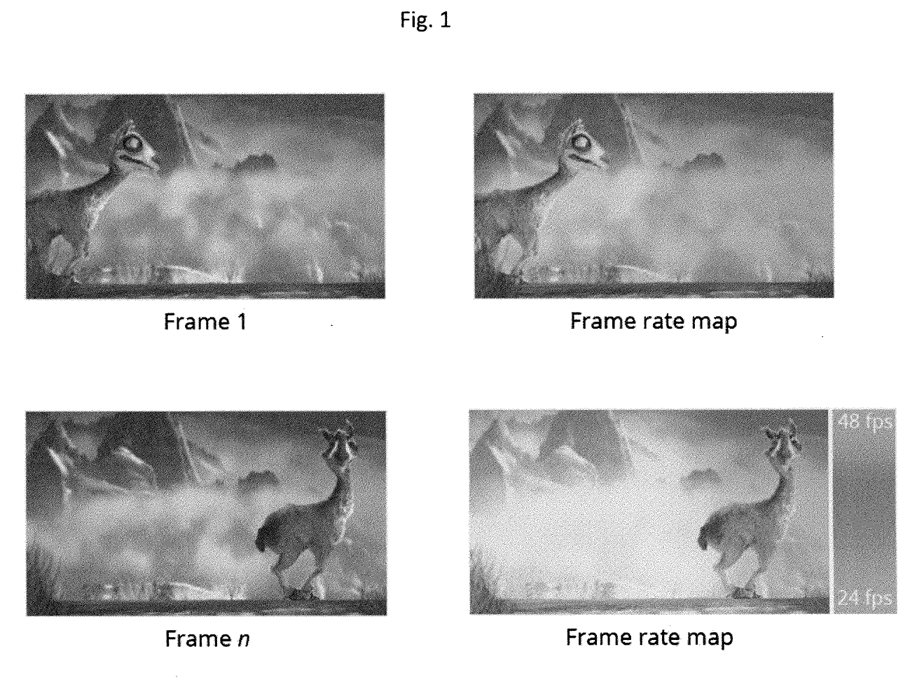

FIG. 1 illustrates how using different presentation frame rates yields different looks of a motion picture.

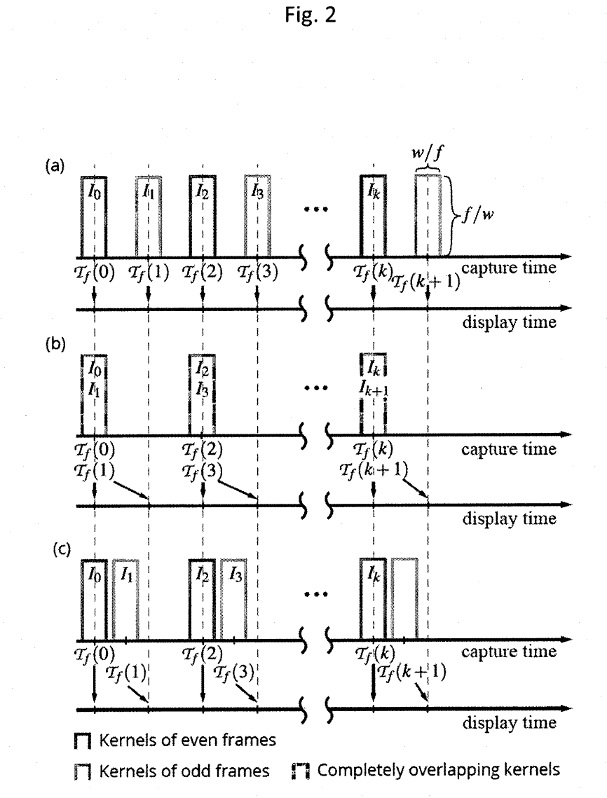

FIG. 2 (a) shows the sampling kernels of a f-fps film captured with the standard 180° shutter.
(b) shows a straightforward emulation of a (f/2)-fps display—the sampling positions of odd display frames are equal to those of even display frames. As a result, the display behaves like a (f/2)-fps one, while still operating at f frames per second.
(c) illustrates how, in order to emulate in-between frame rates one may interpolate the extreme situations from (a) and (b), which is achieved via kernel displacement.

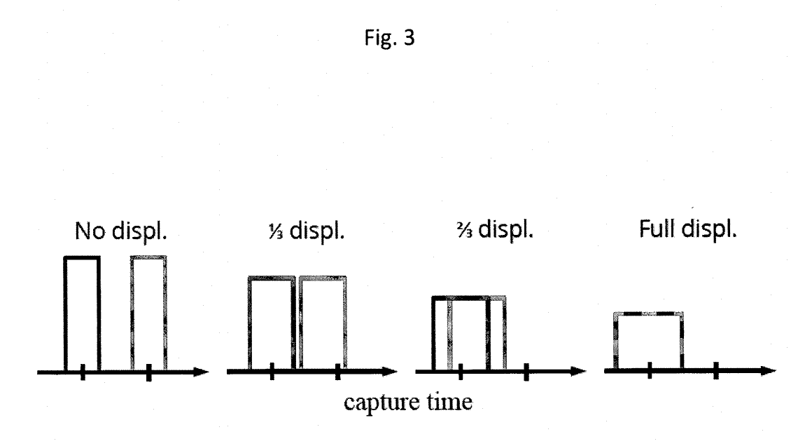

FIG. 3: shows an interpolation between f-fps, 180° and (f/2)-fps, 180°.

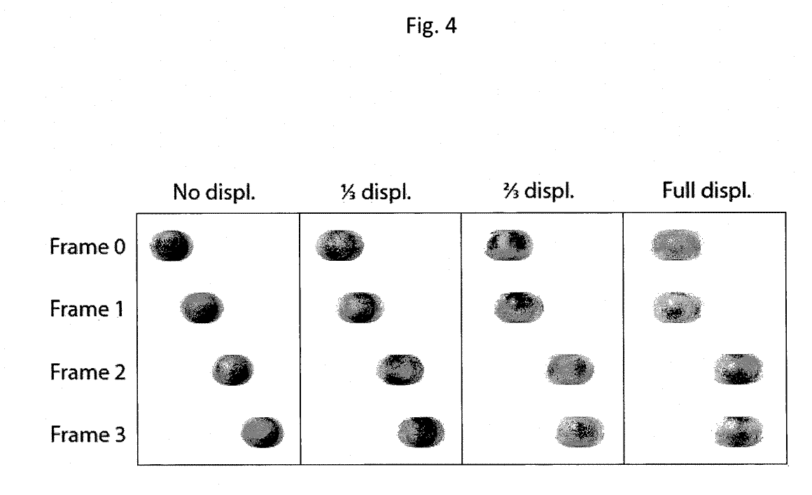

FIG. 4: shows four frames sampled using kernels from FIG. 3 for a scene consisting of a ball moving horizontally left to right.

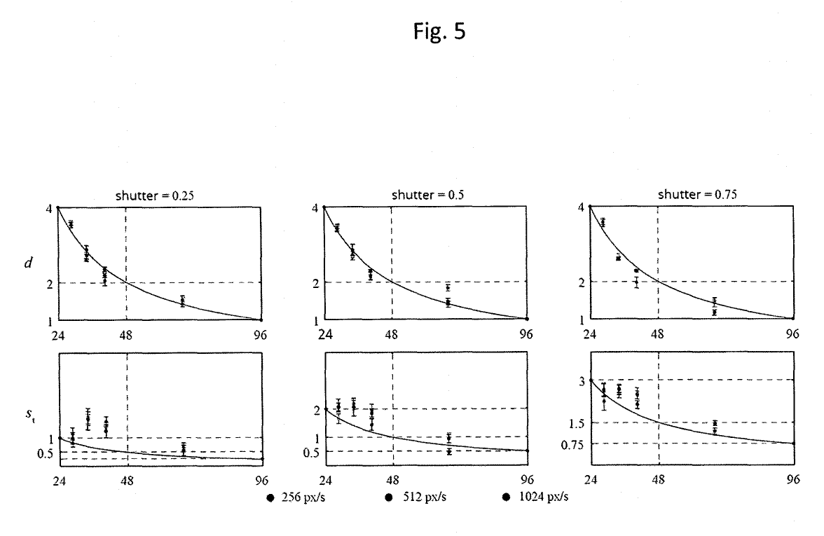

FIG. 5: shows results of the calibration experiment.

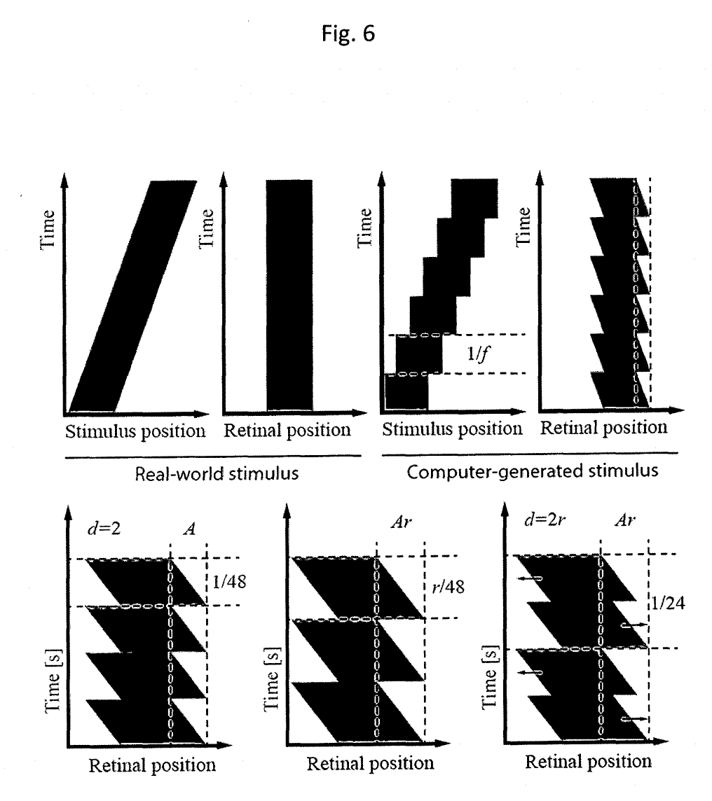

FIG. 6: Top: shows a comparison of a real-world stimulus (left) and a computer-generated stimulus (right). Bottom: shows at d=2 how one may achieve an exact emulation of 48 fps, which has a certain juddering area of width A (left). In the middle figure, some lower frame rate (48/r) fps yields juddering area of width Ar.

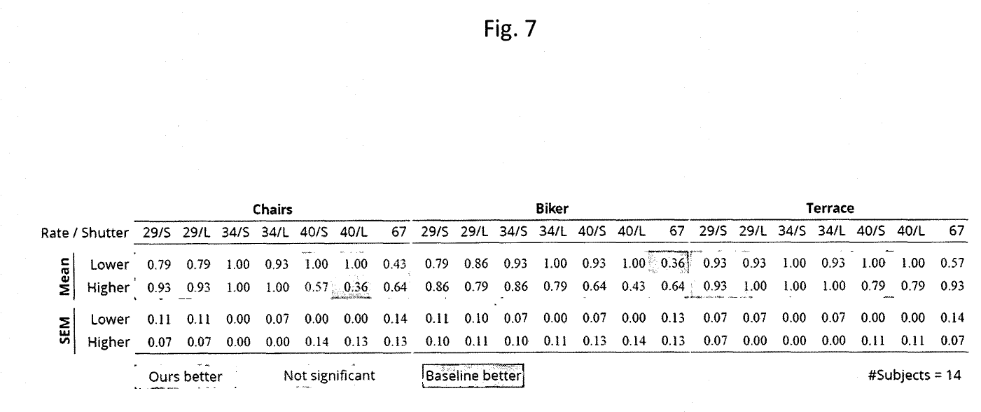

FIG. 7: shows the results of the evaluation experiment.

FIG. 1 illustrates how using different presentation frame rates yields different looks of a motion picture. Higher rates reduce visibility of artifacts such as strobing and judder, whereas lower rates contribute to the “cinematic look” of the film. The method according to the invention enables emulating the look of any presentation frame rate up to the display system frame rate. The frame rate in the content processed with our method can vary continuously, both in the spatial and the temporal dimension.

FIG. 2(a) illustrates sampling kernels of a f-fps film captured with the standard 180° shutter.

The acquisition (i. e., sampling) of a given motion picture frame can be modeled as a convolution of a continuous, time-dependent signal S with a rectangular filter. The temporal support of the filter is proportional to normalized shutter w=α/360° and inversely proportional to frame rate f, and is defined as:

$${rect}_{f , w} ( t ) = \{ \begin{matrix}f \text{/} w & when \vert t \vert < w \text{/} ( 2 f ) , \\ 0 & otherwise .\end{matrix}$$

The temporal sampling positions are always distributed uniformly: for a given frame rate f, the sampling time of frame Iₖ is described by function T_{f}(k): N→R,T_{f} (k)=t₀+k/f, where tₒ is the sampling time of Iₒ. Using the above definitions, the sampled frame sequence is given by:

Iₖ=∫_{-∞}^{∞}S(t)·rect_{f,w}(t−T_{f}(k))dt.

FIG. 2(b) shows a straightforward emulation of a (f/2)-fps display—the sampling positions of odd display frames are equal to those of even display frames. As a result, the display behaves like a (f/2)-fps one, while still operating at f frames per second.

Given a display which operates at f frames per second, a sequence corresponding to the signal S sampled at rate f can be presented directly. It is also straightforward to present content at frame rates lower than f, that result from dividing the presentation frame rate by a positive integer (i.e., f/2, f/3, f/4, . . . ). To this end, it is enough to repeat every frame a fixed number of times, which formally means that for a number of consecutive frames the sampling position of signal S does not change. For instance, to emulate the (f/2)-fps rate every sampling position is used twice, which corresponds to the following modification of T_{f}.

$${T}_{f} ( k ) = \{ \begin{matrix}{t}_{0} + k \text{/} f & for even k , \\ {t}_{0} + ( k - 1 ) \text{/} f & for odd k .\end{matrix}$$

Note, that this leads to a situation in which the acquisition times of odd frames do not exactly correspond to their presentation times (see FIG. 2b for an illustration). As a result of this modified sampling, the display—nominally still operating at f frames per second—emulates an (f/2) Hz display. This is an exact emulation, since the obtained output either closely matches or is equivalent to what would be seen if a real (f/2) Hz display and a camera were used. In a similar fashion, one can achieve even lower frame rates by modifying the number of times each sampling position is repeated.

The above example is a special case of the more general solution that repeats some—but not all—sampling positions. Such a technique can be used to emulate arbitrary frame rates, and in fact, it is routinely used by most video players, which repeat certain frames when required to play content of a lower frame rate on a display with a higher frame rate. This approach, however, introduces additional, unwanted temporal frequencies, causing non-smooth motion (video stutter), which is easily spotted by the observer. For example, one can emulate a 40-fps display at the 48-fps playback rate by repeating every fifth sampling position, but this results in objectionable 8 Hz stutter.

FIG. 2(c) illustrates how, in order to emulate in-between frame rates, one may interpolate the extreme situations from (a) and (b), which is achieved via kernel displacement. The positions of kernels correspond to the sampling time, not to the time when they are actually displayed. The presentation time is always the same and is fully determined by the display system.

The inventive method overcomes the above limitations and enables emulation of arbitrary frame rates below the display frame rate. An important feature of the solution is that the frame rate can be smoothly varied over the spatial and temporal domain without introducing visible artifacts. For clarity of exposition, it is described how to interpolate between f/2 and f frames per second, where f is the display frame rate. The generalization of the technique to lower frame rates is discussed later.

The key observation is that the difference between the extreme cases of f fps and f/2 fps is the position of the odd sampling kernels (FIGS. 2a and 2b). To achieve smooth interpolation between these two situations, one may displace kernels of the odd frames to locations between the two positions corresponding to f/2 and f fps (FIG. 2c). This operation can be defined using a new function T_{f}^{δ}, δε[0,1], interpolating between the original T_{f} and its modified version T′_{f}:

$${T}_{f}^{δ} ( k ) = \{ \begin{matrix}{t}_{0} + k \text{/} f & for even k , \\ {t}_{0} + ( k - δ ) \text{/} f & for odd k .\end{matrix}$$

Note that δ=0 and δ=1 provide the sampling for the f-fps and the (f/2)-fps case, respectively, i.e., T_{f}⁰≡T_{f} and T_{f}¹≡T′_{f})

Although displacing kernel positions interpolates between two frame rates, the exposure time in terms of the shutter angle is not preserved, because the kernels do not change their width. To solve this problem, one may also interpolate the width of sampling kernels using a generalized version of the sampling function:

$${rect}_{f , w}^{γ} ( t ) = \{ \begin{matrix}( 1 - γ / 2 ) f \text{/} w when & \vert t \vert < w \text{/} ( ( 2 - γ ) f ) , \\ 0 & otherwise\end{matrix}$$

where γε[0,1] is an interpolation parameter.

FIG. 3 shows an interpolation between f fps, 180° and f/2 fps, 180°. From left to right: no displacement, one-third displacement, two thirds displacement, and full displacement. Since the shutter angle is constant, the absolute exposure time at both ends is different, and it needs to be smoothly interpolated along with the kernel position.

FIG. 4 shows four frames sampled using kernels from FIG. 3 for a scene consisting of a ball moving horizontally left to right. Note the unequal spacing between ball positions in the second and third column, and frame doubling in the fourth column. Since the positions of sampling kernels are displaced but the frames are displayed at equal intervals, odd frames are displayed “too late” with respect to their capture time.

Given the above definitions, one may define a new interpolated sampling with parameters δ and γ as follows:

Iₖ^{(δ,γ)}=∫_{-∞}^{∞}S(t)·rect_{f,w}^{γ}(t−T_{f}^{δ}(k)dt.

This interpolation technique enables smooth transition between frame rate f/2 and f fps at shutter angle w.

The construction described above does not impose any constraints on frame rate f, and in particular the same technique can be applied to a (f/2) Hz display, resulting in interpolation between the rates of (f/4) and (f/2) frames per second. The overlapping kernels of the (f/2)-fps emulation (FIG. 2b) can be seen as corresponding to individual frames of a “virtual” (f/2) Hz display, and one can displace them jointly to obtain frame rates between (f/4) and (f/2) fps. This procedure can be repeated indefinitely to obtain arbitrarily low frame rates.

In the above construction, only odd sampling kernels were moved, while keeping even kernels unchanged. This results in a slight positioning error of moving objects along the motion direction, and can cause distortion of the image, particularly visible as slanting of vertical lines. To avoid this effect, an alternative implementation may displace both kernels symmetrically in opposite directions, which is achieved by modifying function T_{f}^{δ} as follows:

$${T}_{f}^{δ} ( k ) = \{ \begin{matrix}{t}_{0} + ( k + δ \text{/} 2 ) \text{/} f & for even k , \\ {t}_{0} + ( k - δ \text{/} 2 ) \text{/} f & for odd k .\end{matrix}$$

Although interpolation parameters d and g have been defined globally for the whole image, the above equation can be generalized to allow for spatial variation by letting each pixel assume its own d and g. This requires that each pixel be sampled at arbitrary time-points with a kernel of arbitrary size. In the case of rendered content, such a sampling could be incorporated directly in the renderer. Modern renderers can efficiently simulate finite-time exposure, and the only additional feature we require is that instead of using a single global temporal sampling kernel, many local sampling kernels are used. However, when only an input video is available one needs to resample it in order to obtain required sampling kernels. The invention proposes two solutions to this problem: an accurate but costly filtering of a densely-sampled video or a optic-flow-based warping of a regular video.

If the temporal resolution of the input video is high (hundreds of frames per second), the re-sampling is straight-forward and can be implemented by simple temporal filtering of the input video. Each pixel of each video frame is considered independently, and its value is obtained by averaging pixel values at the corresponding position in all frames that fall within the time interval defined by the kernel. This approach introduces some temporal quantization of the sampling kernel; however, given a sufficiently high input frame rate, this error becomes negligible. The disadvantage of this approach is that generating a densely-sampled video is a costly process.

When sampling a dense input video is not possible, determining the value of a given pixel at an arbitrary time-point is not trivial. In this case, one may approximate arbitrary, spatially varying sampling kernels using frame blending followed by optic-flow-based frame warping, as described below. The preferred format of the input video for this method is a near-shutter, at a relatively high f (e, g., or 96). Such high-frame-rate videos are an emerging standard in the film industry enabling synthesis of various frame rates and shutter combinations, which is achieved by dropping some of the frames of the original video and blending the remaining ones. For instance, by averaging one, two, three, or four consecutive frames, one obtains the corresponding frame of a 90-, 180-, 270-, or 360-degree, (f=4)-fps video, respectively. In-between shutter angles can be approximated by blending between those outputs. The sequences used in the experiment were generated assuming (below) such input. Applying this method is also possible for lower-frame-rate videos: for instance, when the input video is a 24-fps, 90-degree one, it can be temporally up-sampled to 96 fps, degree using frame interpolation. Depending on the initial frame rate and shutter angle combination, different kernel sizes can be reproduced with varying degree of accuracy. At the very least, the input video can be temporally up-sampled ignoring the shutter angle and a simplified version of the below procedure can be implemented, with the first step (frame blending) omitted.

Let Vₖ denote the k-th frame of the f-fps, 360-degree input video, Kₖε [symbol] ²→ [symbol] ⁺ and Dₖε [symbol] ²→[0,1] the maps of kernel sizes and displacements, respectively, and Fₖ, Bₖε [symbol] ²→Z² the corresponding forward and backward optic flow maps (in our experiments we used the technique by Brox et al. [2004] to estimate these). The value at Kₖ(i; j) is the integration time for frame k and the pixel position (i; j) in seconds multiplied by 1=f, and the value Dₖ(i; j) is the displacement parameter d for that pixel.

The method proceeds in two steps. First, one takes an input frame corresponding to the desired presentation time, and locally blends it with neighboring frames to approximate the required kernel size (pixel indexing is omitted for clarity, all operations are performed pixel-wise):

$${\hat{V}}_{k} = ( clamp ( {K}_{k} ; 0 , 1 ) \cdot {V}_{k} + {\sum }_{n = 1}^{∞} \frac{1}{2} clamp ( {K}_{k} - 2 n + 1 ; 0 , 2 ) \cdot ( {V}_{k - n} + {V}_{k + n} ) ) \text{/} {K}_{k}$$

where clamp(x;a;b)=min(max(a;x);b).

Second, one warps the frame by re-projecting each pixel to its position in the past or in the future (depending if the frame is even or odd), with the time-point being determined by the desired kernel displacement at the given pixel:

$${\hat{V}}_{k} ( i , j ) ↦ \{ \begin{matrix}{\hat{V}}_{k} ( ( i , j ) + \frac{1}{2} \cdot {D}_{k} ( i , j ) \cdot {F}_{k} ( i , j ) ) & for even k \\ {\hat{V}}_{k} ( ( i , j ) + \frac{1}{2} \cdot {D}_{k} ( i , j ) \cdot {B}_{k} ( i , j ) ) & for odd k\end{matrix}$$

The arrow notation \hat{V}ₖ(i, j) [symbol] \hat{V}ₖ(i′, j′) means, that the pixel in the input image at the position (i; j) is warped to the position (i′; j′) in the output image.

After the warping the actual kernel at any given position in \hat{V}ₖ is not exactly equal to that given by Kₖ and Dₖ for that position, but under the assumption that the kernel displacement/size and optical flow are locally constant, the outcome is equivalent to the filtering solution. Since this method blends few frames to approximate different kernel sizes, its accuracy in this respect is admittedly lower when compared to the dense video approach. However, it has the advantage of a relatively low computation cost, enabling a real-time implementation, e. g., in TV-sets or computer games.

In order to investigate the perceptual effect of the inventive interpolation technique, one may establish a mapping between combinations of actual frame rates and shutter angles and the interpolation parameters δ and γ in the range 24-96 fps. Although the inventive technique is not limited to f=96, it is believed that this is the most interesting scenario for the method, because it allows for an exact emulation of both standard 24 fps and HFR 48 fps. The mapping was derived in the following calibration experiment.

Ten subjects, including two authors, took part in the experiment. An Asus PG278Q display (27 inch diagonal, native resolution 2560×1440 px, maximum refresh rate 144 Hz) and an Nvidia GeForce GTX 970 graphics card were used. This configuration supports Nvidia G-Sync technology, which enables the system to refresh the display as soon as the frame has been rendered, without waiting for the next refresh cycle of the display. Thus, by putting the process to sleep for an appropriate number of milliseconds the display could be set programmatically to any frame rate below 144 Hz on the fly. The subjects were seated ca. 50 cm from the display, but were allowed to freely change their position. The experiment was conducted in controlled office lighting conditions.

The stimulus was a vertical 100×1440 px light-gray bar moving left-to-right on a dark-gray background. When the bar reached the right end of the display, the motion was restarted from the left end of the display. The subjects could alternate between the reference bar and the test bar by pressing the left and the right arrow key, respectively. Both bars were moving with velocity vε{256 px/s, 512 px/s, 1024 px/s}. The reference bar was displayed with veridical frame rate fᵣε{29, 34, 40, 68} and normalized shutter angle sᵣε{0.25, 0.5, 0.75}. The test bar was always displayed using our technique at frame rate fₜ=96 fps. Kernel displacement of the test bar could be adjusted via parameter dε[1,4] by pressing the plus and the minus key, and shutter angle sₜ could be adjusted in the range of [0,4] by pressing ‘[‘and’]’ key. Values of dε[1,2] corresponded to δε[0,1], whereas values of dε[2,4] corresponded to δε[0,1] assuming “virtual” frame rate of f/2=48 fps achieved by joint displacement of overlapping kernels. In a single trial, the participant was asked to adjust the kernel displacement d and shutter angle sₜ of the test bar so that its appearance matched the appearance of the reference bar as closely as possible, and confirm the settings with ‘Enter’ key. The whole session consisted of all 3·4·3=36 possible trials in random order, and the time to perform the task was not limited. No test was done for fᵣε{24, 48, 96} since the method can emulate these rates exactly.

FIG. 5 shows the results of the calibration experiment. Each point is the average of responses of to subjects, and the error bars are the standard errors of the mean. The upper row corresponds to the displacement parameter d and the lower row—to the shutter angle parameter sₜ. The black solid lines in the upper row indicate the displacement proportional to the inverse of the frame rate. The solid lines in the lower row indicate constant absolute exposure time.

As can be seen, d is approximately inversely proportional to the reference frame rate, however, for 34 and 40 fps this value tends to be lower. This is accompanied by significantly increased blur in comparison to what would be predicted by simple matching of the absolute exposure time. In our experience, the most important factor determining the similarity of the two bars for frequencies between 24 and 48 fps, was the perceived intensity of judder at the bar edges.

FIG. 6 (top) shows a comparison of a real-world stimulus (left) and a computer-generated stimulus (right). In each pair the horizontal position of a moving vertical bar is shown. Due to smooth pursuit eye motion, the stimulus' image is stabilized on the retina. While real-world stimuli generate constant signal on the retina, computer generated stimuli have regions of time-varying periodic signal near the edges, because the bar “stays behind” due to its position changing in discrete steps. One such region is delineated by the vertical dashed lines. Depending on the frame rate of the display, this will cause judder and/or hold-type blur.

FIG. 6 (bottom) shows that at d=2 one achieves an exact emulation of 48 fps, which has a certain juddering area of width A (left). In the middle figure, some lower frame rate (48/r) fps yields juderring area of width Ar. Setting the displacement parameter d in the emulation to 2r (right), which corresponds to a position on the black solid line in FIG. 5, gives a juderring area of equal width, however, the frequency of flicker is lower (24 Hz).

In other words, the displacement values at the black solid line in FIG. 5 result in the same juddering area. However, the judder of our emulation has lower frequency than that of the reference stimulus (24 Hz vs. 29, 34, or 40 Hz).

When the frame rate of the stimulus exceeds the critical flicker frequency, the changing signal is averaged by the visual system, and the bar appears blurred (so-called holdtype blur). Thus, for the highest frame rate (68 fps), the dominant parameter is the amount of blurring at the edges, since virtually no judder is visible in this case.

The obtained data points can be interpolated and used to define improved correspondence between intended frame rate and interpolation parameters δ and γ.

In order to show that the inventive frame rate emulation leads to possibly similar appearance for real-world content a perceptual evaluation experiment is presented in which one compares the proposed technique against two baseline methods. Sixteen naïve, non-expert, paid subjects took part in the experiment. All had normal or corrected-to-normal vision. The experimental setup was the same, as in the calibration experiment.

Three real-world video sequences were used as stimuli. The reference sequence was rendered using veridical frame rates fᵣε{29,34,40,68} and shutter sᵣε{fᵣ/96.2·fᵣ/96}(except for fᵣ, where only sᵣ=68/96 was used). The rendering of different frame rates and shutter angles was achieved by interpolation and averaging of consecutive frames of the original 96 fps, near-360° videos. The test sequences were synthesized using our technique at frame rate fₜ=96 fps, with displacement d and shutter sₜ locally adjusted according to the velocities in the video, as determined in the calibration experiment (see FIG. 5). Arbitrary shutter angles were approximated by blending two nearest shutter angles possible to obtain via averaging of consecutive frames. The comparison sequence was rendered using a baseline method at frame rate f_{b}ε{48,96} when fᵣ=68 and f_{b}ε{24,48} otherwise. The value of baseline shutter s_{b}, was set to match the absolute exposure time of the reference video (the same amount of blur).

The subjects could switch between the reference, test, and the comparison sequence using the arrow keys, with the ‘Up’ key corresponding to the reference bar, and the ‘Left’/‘Right’ keys corresponding to the test and comparison sequence in random arrangement. In a single trial, the subject was asked to select one of the two sequences that looked more similar to the reference sequence and confirm the choice with the ‘Enter’ key. One session consisted of all 42 possible trials in random order. The subjects had unlimited time to complete the experiment.

Before the experiment, a control session was performed in which the frame rate of the reference and the test sequence was set to either 24, 48, or 96 fps and the comparison sequence was set to one of the remaining two frame rates (thus the test sequence was identical to the reference, while the comparison sequence had a significantly different frame rate). Two of the subjects were unable to perform above the chance level in this setting and where subsequently excluded from our analysis.

FIG. 7 shows the results of the evaluation experiment. Each column corresponds to one combination of a scene, frame rate, and shutter (smaller or larger) as compared against two baseline solutions (the nearest lower standard frame rate and the nearest higher standard frame rate). The numbers indicate how often the inventive method was chosen over the corresponding baseline solution.

In general, the inventive technique turned out to be more similar to the reference than the baseline sequences. The baseline methods used nearest standard cinematic frame rates and had matching amount of blur, which can be considered the state-of-the art in terms of matching the film look. There were only two cases where our method performed significantly worse than the baseline, both at higher frame rates, and one of them at 68 fps, where judder is practically invisible, and the only difference in appearance can be attributed to the blur profile. The results of this experiment prove that our technique provides a very good approximation of the look of other frame rates.

The inventive technique requires sampling the scene at arbitrary times with a kernel of arbitrary size. In the case of real-world content, an emerging standard is to film the scene at 120 Hz with a nearly 360° shutter to enable synthesis of several frame rates and shutter combinations. This temporal resolution might not be sufficient to smoothly interpolate between various sampling kernels, however, it is high enough to estimate optical flow quite reliably and thus to obtain required level of precision via frame interpolation. If required, varying shutter size can be obtained by adding appropriate amounts of blur along the motion direction. In the case of rendered content, achieving such sampling is straightforward and could be incorporated directly in the renderer. Alternatively content can be rendered with a very high frame rate and the required frames can be synthesized in a post-process.

The invention can be applied by an artist to apply accurate, manual tweaks to the video, based on his or her artistic vision. With standard techniques, the artist is forced to choose from a very limited set of possible frame rates. The benefits of smooth spatial frame rate variation compared to simple combination of two frame rates are clear: In the two-frame-rates approach, one needs to carefully decompose the scene into layers (figure-background) to avoid artifacts at the locations of the framerate “seams”. Such a solution, however, may lead to significant artifacts when the decomposition is imperfect. In contrast, in our approach it is enough to scribble a mask with a soft brush, and the interpolation will produce seamless results. Similarly, smooth temporal variation of the frame rate can help make the moment of transition unnoticeable when an abrupt frame-rate change is not desired.

In another application, the velocities within the frame can be automatically analyzed and the appropriate frame rate can be applied locally. For instance, depending on the camera parameters such as focal length and frame rate there are certain recommendations as to the maximum comfortable on-screen speed of any object in the scene [Hummel 2002, p. 887]. The rule of thumb is that at 24 frames per second no object should cross the entire screen in under 7 seconds, and that the maximum allowable speed is proportional to the frame rate [Samuelson 2014, p. 314]. Using these guidelines, the inventive technique can automatically minimize the frame rates across the screen in order to maximize the cinematic look, yet without introducing objectionable artifacts. Conversely, by emulating higher frame rates more dynamic scene changes can be locally allowed, while overall 24 frames per second are maintained.

In a further embodiment of the invention, the networks may also be used for stereoscopic presentation. The image separation protocols between eyes, for example in timesequential shutter glasses, might cause additional motion perception artifacts are taken into consideration.

Appendix A is a Matlab program implementing a method according to claim 1.

```
% Input frame rate - the temporal resolution of the input sequence that has
% been pre-interpolated from a regular sequence (24fps, 48fps, etc.)
% or pre-rendered. This frame rate is assumed to be high enough to
% approximate fully continuous temporal sampling.
% Alternatively one could interpolate frames “on-the-fly” within the script
% using optic flow to obtain arbitrary precision.
infr = 480;
% Intended frame rate - the frame rate of the display system.
% We will emulate all frame rates between outfr/2 and outfr
% but the real output will be always at frame rate outfr
outfr = 48;
skip = infr/outfr;
assert(mod(skip, 2) == 0) % (infr / outfr must be divisible by 2)
% Input sequence
startframe = 0;
endframe = 5759;
framesdir = ‘.\results\tos\interpolated1\’;
% Frame rate masks - kernel displacement for given time and location.
% Black means full displacement (frames are doubled; frame rate outfr/2),
% white means no displacement (frames are at correct positions; frame
rate outfr).
% Grey levels - emulation of fractional displacements (in-between
frame rates).
maskdir = ‘.\tos1_mask\’;
% Output directory
outdir = ‘.\tos1_out_test\’;
% Current output frame number - we start from 2 to have some margin for
% sampling the past.
ff = 2;
% In each interation we output 2 frames
for f = startframe+ff*skip:2*skip:endframe−2*skip+1
  % Read a chunk of frames (f−skip/2+1, ..., f+skip/2)
  C = { };
  for i=1:skip
    C{i} = im2double(imread(sprintf(‘.\\%s\\%04d.jpg’, framesdir,
    f+i−skip/2)));
  end
  % At first both frames are the same (frame rate is outfr/2)
  F1 = C{skip/2};
  F2 = C{skip/2};
  % Read frame rate mask for the current time
  M = im2double(imread(sprintif(‘.\\%s\\%04d.jpg’, maskdir, ff/2−1)));
  % Progresively replace parts of the output frames with
  % less displaced kernels according to the frame rate masks.
  for i=2:2:skip−2
    frac = i/skip;
    B = (M >= frac);
    % We assume that we keep fixed abslolute exposure time
    % (as in the input sequence), hence we assign values from a single
    % image in C. If interpolation between different exposures is also
    % needed one needs to average multiple imges from C, add blur
    % on-the-fly according to optic flow, or provide
    % an input sequence that has already additional blur factored in
    F1(B) = C{skip/2−i/2}(B);
    F2(B) = C{skip/2+i/2}(B);
  end
  % Output the two frames
  imwrite(F1, sprintf(‘.\\%s\\%04d.jpg’, outdir, ff), ‘Quality’, 98);
  ff = ff + 1;
  imwrite(F2, sprintf(‘.\\%s\\%04d.jpg’, outdir, ff), ‘Quality’, 98);
  ff = ff + 1;
end
```

1. A method for emulating frame rates in a video, comprising the step of:
obtaining a sequence of frames to be displayed at a presentation frame rate to a human viewer,
characterized in that
the sequence of frames is obtained such that an emulated frame rate of at least a region within a frame of the displayed sequence is perceived to be lower than the presentation frame rate by the human viewer.

2. The method of claim 1, wherein the emulated frame rate can be varied.

3. The method of claim 2, wherein the emulated frame rate can be varied between different regions of a frame and/or between frames.

4. The method of claim 1, wherein the emulated frame rate can be varied continuously.

5. The method of claim 1, wherein a difference between sampling times of some region of consecutive frames varies periodically,

6. The method of claim 5, wherein said difference either equals zero or belongs to a set of at least two, strictly greater than zero, pair-wise different parameters D and within said period all parameters from D are used at least once.

7. The method of claim 6, wherein D contains exactly two parameters, wherein each parameter is used exactly once within said period, and the distance between the two occurrences of parameters from D is equal to half the period length.

8. The method of claim 7, wherein said period has length exactly 2, 4 or 8 frames.

9. The method of claim 6, wherein said difference within said period on average equals the inverse of said presentation frame rate.

10. The method of claim 1, wherein a frame is obtained based on a shutter angle of a camera.

11. The method of claim 1, wherein a frame is obtained by sampling from a sequence of input frames.

12. The method of claim 1, wherein sampling a frame from the sequence of input frames comprises interpolating between two subsequent input frames.

13. The method of claim 1, wherein the frames are obtained by controlling capture times of a video camera.

14. The method of claim 1, wherein the frames are obtained by rendering.

15. The method of claim 1, wherein a frame is obtained based on a displacement parameter (δ).

16. The method of claim 9, wherein the displacement parameter (δ) is set automatically.

17. The method of claim 9, wherein the displacement parameter (δ) is set by a user.

18. The method of claim 1, wherein the veridical frame rate is 48 fps, 60 fps, 96 fps, 120 fps or 144 fps.

19. The method of claim 1, implemented on a computer.

20. The method of claim 1, wherein the sequence of frames corresponds to a film shot.

21. A non-volatile medium, storing a video generated by a method according to claim 1.

22. A computer program product, comprising instructions that, when executed by a computer, implement a method according to claim 1.

23. A video camera, wherein a capture time of a frame is controlled in order to obtain a sequence of frames to be displayed at a presentation frame rate to a human viewer,
characterized in that
the sequence of frames is obtained by controlling the capture time such that an emulated frame rate of at least a region within a frame of the displayed sequence is perceived to be lower than the presentation frame rate by the human viewer.
